(19) United States
(12) Patent Application Publication
(10) Pub. No.: US 2024/0362269 A1
(43) Pub. Date: Oct. 31, 2024

(54) SYSTEMS AND METHODS FOR CROSS-MODAL RETRIEVAL BASED ON A SOUND MODALITY AND A NON-SOUND MODALITY

(71) Applicant: ADOBE INC., SAN JOSE, CA (US)

(72) Inventors: Ho-Hsiang Wu, Morrisville, NC (US); Oriol Nieto, Oakland, CA (US); Justin Jonathan Salamon, San Francisco, CA (US)

(21) Appl. No.: 18/308,970

(22) Filed: Apr. 28, 2023

(51) Int. Cl. G06F 16/632; G06F 16/638; G06F 16/68

(52) U.S. Cl. CPC G06F 16/632; G06F 16/638; G06F 16/686

(57) ABSTRACT

Systems and methods for cross-modal retrieval are provided. According to one aspect, a method for cross-modal retrieval includes obtaining a query describing a sound using a query modality other than a sound modality; encoding the query to obtain a query embedding using a query encoder network for the query modality and a query projection network, wherein the query projection network includes a self-attention layer, and wherein the query embedding is in a joint embedding space for the query modality and the sound modality; and providing a response including an audio sample based on the query embedding, wherein the audio sample includes the sound.

### BACKGROUND

The following relates to cross-modal retrieval. Cross-modal retrieval refers to tasks relating to retrieving information in one modality (such as a sound modality) using information in a different modality (such as a text modality).

Conventional systems can employ machine learning models to perform cross-modal retrieval. However, current cross-modal retrieval systems may not be able to retrieve a search result in a sound modality that accurately reflects the content of a search prompt in a non-sound modality. There is therefore a need in the art for systems and methods for cross-modal retrieval that can provide an accurate result in a sound modality based on a query in a non-sound modality.

### SUMMARY

Embodiments of the present disclosure provide a cross-modal retrieval system that retrieves an audio sample in response to a query in a non-sound modality (such as a text modality). In some cases, the cross-modal retrieval system generates an embedding (e.g., a vector representation) for the query in a joint embedding space using a self-attention layer of a machine learning model. In some cases, the cross-modal retrieval system identifies the audio sample by comparing the query embedding to an audio sample embedding for the audio sample in the joint embedding space.

By generating the query embedding in the joint embedding space and comparing the query embedding to the audio sample embedding in the joint embedding space, the cross-modal system is able to identify an audio sample that more closely matches the query than if the query embedding and the audio sample embedding were embedded in different embedding spaces.

Furthermore, in some cases, by generating the query embedding using the self-attention layer, the cross-modal system is able to generate a more accurate encoding than conventional cross-modal retrieval systems, further increasing the accuracy of the match between the query embedding and the audio sample embedding and therefore the match between the query and the audio sample.

A method, apparatus, non-transitory computer readable medium, and system for cross-modal retrieval are described. One or more aspects of the method, apparatus, non-transitory computer readable medium, and system include obtaining a query describing a sound using a query modality other than a sound modality; encoding the query to obtain a query embedding using a query encoder network for the query modality and a query projection network, wherein the query projection network includes a self-attention layer, and wherein the query embedding is in a joint embedding space for the query modality and the sound modality; and providing a response including an audio sample based on the query embedding, wherein the audio sample includes the sound.

A method, apparatus, non-transitory computer readable medium, and system for cross-modal retrieval are described. One or more aspects of the method, apparatus, non-transitory computer readable medium, and system include identifying a training dataset including an audio sample in a sound modality and a corresponding sample in a corresponding sample modality other than the sound modality; encoding the corresponding sample to obtain a corresponding sample embedding using a query encoder network for the corresponding sample modality and a query projection network, wherein the query projection network includes a first self-attention layer, and wherein the corresponding sample embedding is in the joint embedding space; encoding the audio sample to obtain an audio embedding using an audio encoder network for the sound modality and an audio projection network, wherein the audio projection network includes a second self-attention layer, and wherein the audio embedding is in the joint embedding space; and training the query projection network based on the audio embedding and the corresponding sample embedding.

An apparatus and system for cross-modal retrieval are described. One or more aspects of the apparatus and system include at least one processor; a memory storing instructions executable by the at least one processor; a query encoder network configured to generate a sequence of token embeddings based on a query in a query modality other than a sound modality, wherein the query describes a sound; and a query projection network configured to encode the sequence of token embeddings to obtain a query embedding in a joint embedding space for the query modality and the sound modality, wherein the query projection network includes a self-attention layer.

### BRIEF DESCRIPTION OF THE DRAWINGS

FIG. 1 shows an example of a cross-modal retrieval system according to aspects of the present disclosure.

FIG. 2 shows an example of a retrieval apparatus according to aspects of the present disclosure.

FIG. 3 shows an example of query-based audio retrieval according to aspects of the present disclosure.

FIG. 4 shows an example of audio-based response retrieval according to aspects of the present disclosure.

FIG. 5 shows an example of a method for cross-modal retrieval according to aspects of the present disclosure.

FIG. 6 shows an example of a method for providing a response to a query according to aspects of the present disclosure.

FIG. 7 shows an example of a method for providing an additional response to an audio query according to aspects of the present disclosure.

FIG. 8 shows an example of a method for training a query projection network according to aspects of the present disclosure.

FIG. 9 shows an example of training a query projection network and an audio projection network according to aspects of the present disclosure.

### DETAILED DESCRIPTION

Embodiments of the present disclosure relate to cross-modal retrieval. Cross-modal retrieval refers to tasks relating to retrieving information in one modality (such as a sound modality) using information in a different modality (such as a text modality). Conventional systems can employ machine learning models to perform cross-modal retrieval. However, current cross-modal retrieval systems may not be able to retrieve a search result in a sound modality that accurately reflects the content of a search prompt in a non-sound modality.

For example, conventional audio-visual contrastive models can be applied to applications such as localizing visual sound, cross-modal retrieval, and zero-shot classification, and conventional audio-text models have been applied to music (e.g., for genre classification and tagging) and to environmental sounds (e.g., for language-based audio retrieval and zero-shot classification tasks). However, existing cross-modal retrieval systems for a sound modality may not fully leverage information available in a search prompt in a non-sound modality or in a search result in a non-sound modality for a search prompt in a sound modality.

Embodiments of the present disclosure provide a cross-modal retrieval system that retrieves an audio sample in response to a query in a non-sound modality (such as a text modality). In some cases, the cross-modal retrieval system generates an embedding (e.g., a vector representation) for the query in a joint embedding space using a self-attention layer of a machine learning model. In some cases, the cross-modal retrieval system identifies the audio sample by comparing the query embedding to an audio sample embedding for the audio sample in the joint embedding space.

By generating the query embedding in the joint embedding space and comparing the query embedding to the audio sample embedding in the joint embedding space, the cross-modal system is able to identify an audio sample that more closely matches the query than if the query embedding and the audio sample embedding were embedded in different embedding spaces.

Furthermore, in some cases, by generating the query embedding using the self-attention layer, the cross-modal system is able to generate a more accurate encoding than conventional cross-modal retrieval systems, further increasing the accuracy of the match between the query embedding and the audio sample embedding and therefore the match between the query and the audio sample.

An embodiment of the present disclosure is used in a cross-modal audio retrieval context. In an example, a user provides a natural language search prompt that describes a sound including “a loud thud followed by gasps and laughter” (e.g., a sound including a sequentially ordered qualified sub-sound followed by a complex sub-sound) to the cross-modal retrieval system. The cross-modal retrieval system encodes the natural language search prompt in a joint embedding space and identifies an audio sample embedding that matches the encoded search prompt in the joint embedding space. The cross-modal system then retrieves an audio sample that corresponds to the audio sample embedding (where the audio sample is either a sample that includes the sound or is a sample that includes the sound in addition to other sounds). In some cases, the cross-modal retrieval system also identifies corresponding timestamp information for the audio sample.

The cross-modal retrieval system provides the retrieved audio sample (and in some cases the corresponding timestamp information) to the user. Therefore, in some cases, the user can use the cross-modal retrieval system to accurately retrieve a complex, sequentially ordered sound based on a complex natural language search prompt that is not constrained by a fixed vocabulary. In some cases, because the retrieved audio sample corresponds to timestamp information, the search prompt can be used to find a timestamped portion of a large audio file including the sound. The cross-modal retrieval system therefore allows a user to retrieve an audio sample or a time-indexed portion of an audio sample using a non-audio search prompt (which as described above can include a complex, natural language text prompt), providing a powerful tool for users such as audio editors who search for and through audio files.

An embodiment of the present disclosure is used in a cross-modal video retrieval context. For example, as described above, a user can provide a non-audio search prompt (such as a natural language search prompt) to the cross-modal retrieval system to retrieve an audio sample that matches the non-audio search prompt. In an example, the audio sample is associated with (for example, by being included in or through an association in a data schema) a video sample. In some cases, the association corresponds to timestamp information for the audio sample and timestamp information for the video sample. Therefore, by retrieving the audio sample based on the non-audio search prompt, the cross-modal retrieval system can retrieve a corresponding video sample as well. The cross-modal retrieval system therefore allows a user to retrieve a video sample or a time-indexed portion of a video sample using a non-audio search prompt (which as described above can include a complex, natural language text prompt), providing a powerful tool for users such as video editors who search for and through video files.

Because some embodiments of the present disclosure use a joint embedding space to compare a query embedding and an audio embedding, in some cases, a query modality (e.g., a text, image, or video modality) can be used to accurately retrieve an audio response in a sound modality. Likewise, an audio query modality can be used to accurately retrieve a result in a response modality, such as a text, image, or video modality. Furthermore, in some cases, because the response is provided based on a comparison of embeddings in a joint embedding space, accurate matches between a query and a response are not constrained to predetermined matches between a predetermined set of search terms and a predetermined set of matching results. By contrast, conventional cross-modal retrieval systems may use a tagging system, which relies on a predetermined set of search terms and a predetermined set of tagged matching results.

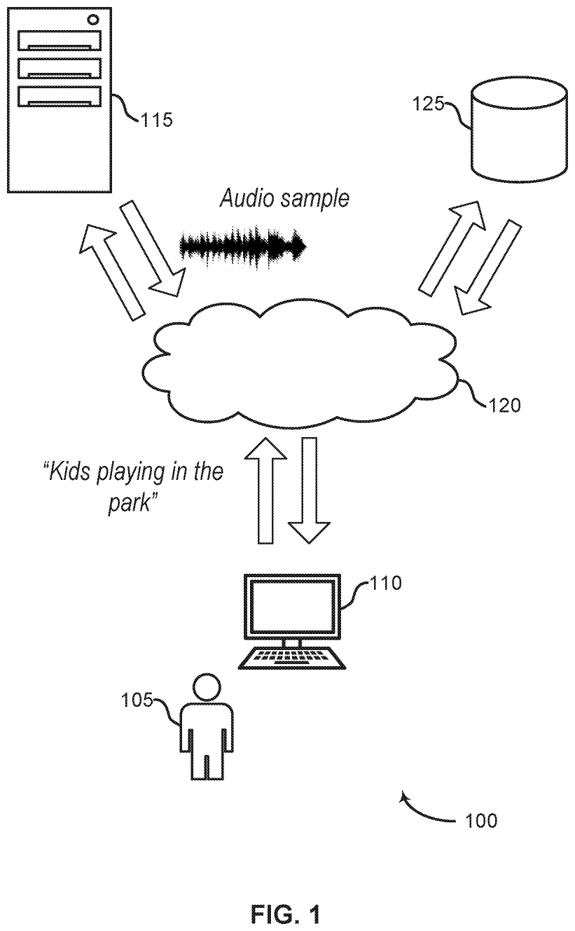

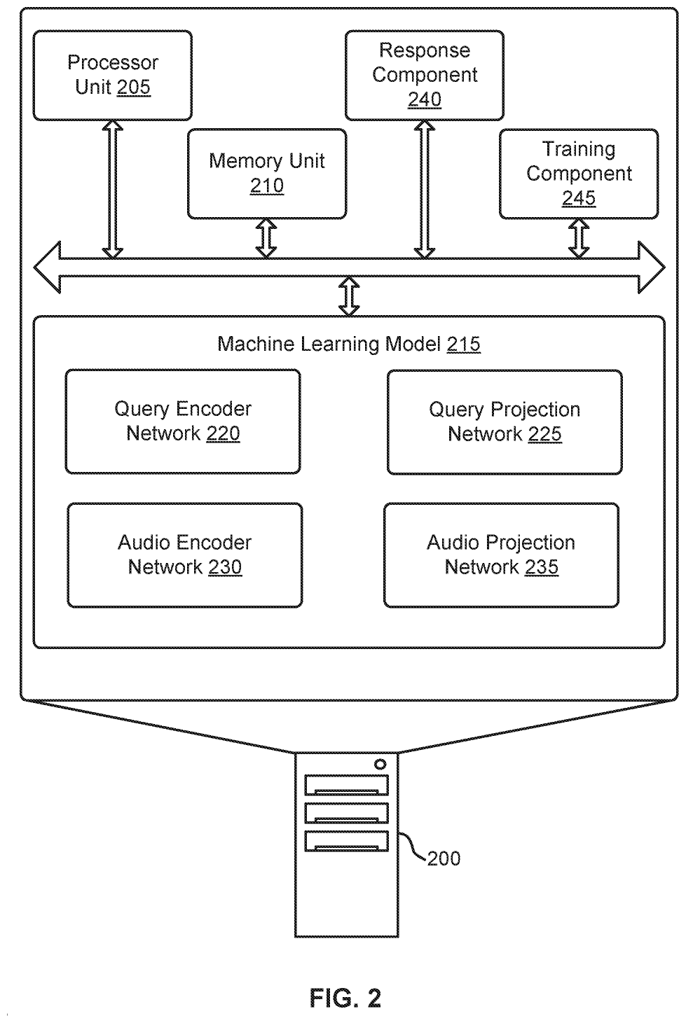

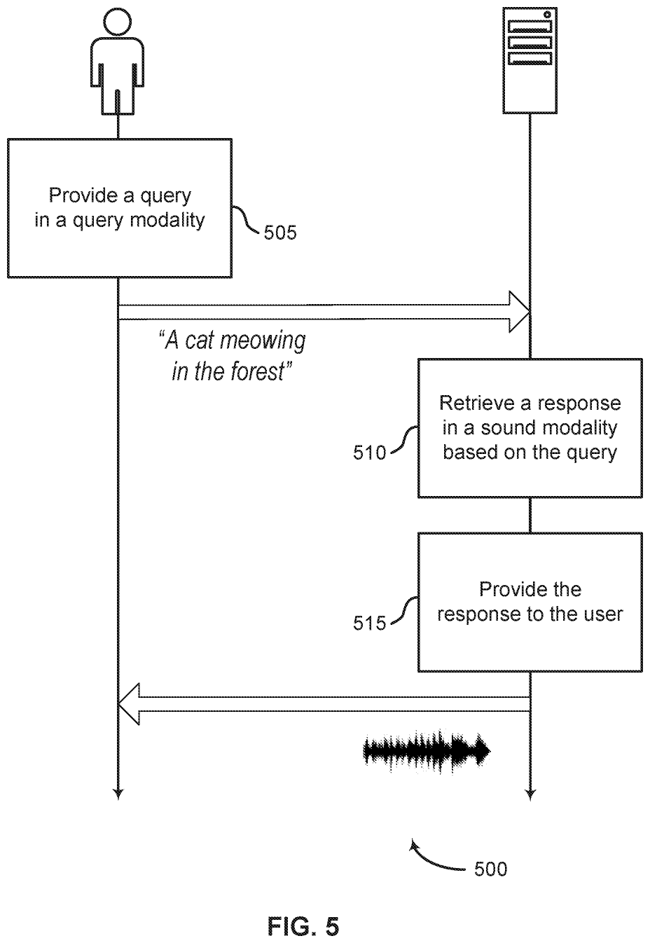

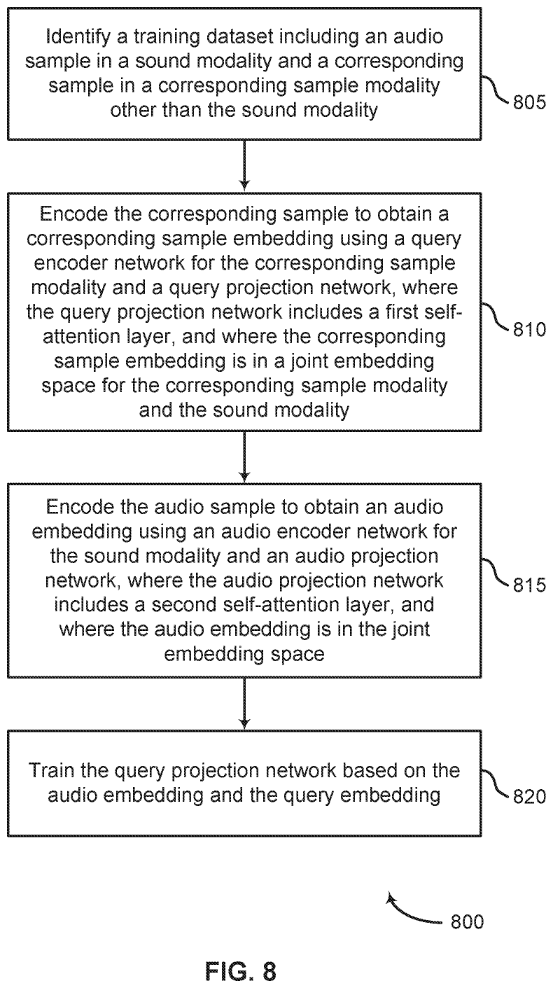

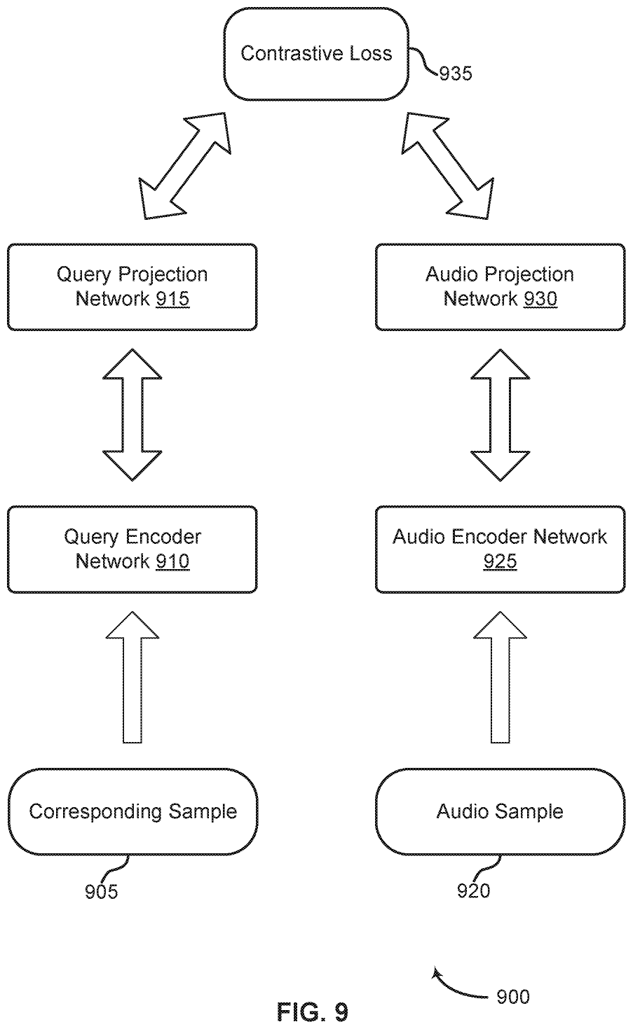

Example applications of the present disclosure in the cross-modal audio retrieval context are provided with reference to FIGS. 1 and 2. Details regarding the architecture of the cross-modal retrieval system are provided with reference to FIGS. 2-4. Details regarding a process for cross-modal retrieval are provided with reference to FIGS. 5-7. Details regarding a process for training the machine learning model are provided with reference to FIGS. 8-9.

### Retrieval System

A system and an apparatus for cross-modal retrieval are described with reference to FIGS. 1-4. One or more aspects of the system and the apparatus include at least one processor; a memory storing instructions executable by the at least one processor; a query encoder network configured to generate a sequence of token embeddings based on a query in a query modality other than a sound modality, wherein the query describes a sound; and a query projection network configured to encode the sequence of token embeddings to obtain a query embedding in a joint embedding space for the query modality and the sound modality, wherein the query projection network includes a self-attention layer.

Some examples of the system and the apparatus further include a response component configured to provide a response including an audio sample based on the query embedding, wherein the audio sample includes the sound.

Some examples of the system and the apparatus further include an audio encoder network configured to generate a sequence of audio token embeddings based on an audio sample. Some examples further include an audio projection network configured to encode the sequence of audio token embeddings to obtain an audio embedding in the joint embedding space, wherein the audio projection network includes a second self-attention layer.

Some examples of the system and the apparatus further include a training component configured to identify a training dataset including an audio sample in the sound modality and a corresponding sample in a corresponding sample modality other than the sound modality and to train the query projection network based on an audio embedding of the audio sample and a corresponding sample embedding of the corresponding sample.

Some examples of the system and the apparatus further include an audio encoder network configured to generate a sequence of audio query token embeddings based on an audio query. Some examples further include an audio projection network configured to encode the sequence of audio query token embeddings to obtain an audio query embedding in the joint embedding space, wherein the audio projection network includes a second self-attention layer, and wherein the audio query embedding is in the joint embedding space. Some examples further include a response component configured to provide a response to the audio query, wherein the response comprises the query modality.

FIG. 1 shows an example of a cross-modal retrieval system 100 according to aspects of the present disclosure. The example shown includes user 105, user device 110, retrieval apparatus 115, cloud 120, and database 125.

Referring to FIG. 1, in an example, user 105 provides a query in a query modality (such as a text query in a text modality, e.g., “Kids playing in the park”) to retrieval apparatus 115 via user device 110 (for example, via a graphical user interface displayed on user device 110 by retrieval apparatus 115). In some cases, retrieval apparatus 115 encodes the query in a joint embedding space. In some cases, retrieval apparatus 115 compares the encoded query to an encoded audio sample in the joint embedding space and determines that the encoded query matches the encoded audio sample. In some cases, the encoded audio sample is stored in database 125.

In some cases, retrieval apparatus 115 determines that the encoded audio sample matches the encoded query, and based on the determination, retrieves an audio sample corresponding to the encoded audio sample (for example, from database 125) and provides the audio sample to the user (for example, via the graphical user interface displayed on user device 110).

According to some aspects, user device 110 is a personal computer, laptop computer, mainframe computer, palmtop computer, personal assistant, mobile device, or any other suitable processing apparatus. In some examples, user device 110 includes software that can transmit, receive, and/or display information that can be transmitted in visual and/or auditory form, including but not limited to text, images, video, audio, etc.

According to some aspects, a user interface enables user 105 to interact with user device 110. In some embodiments, the user interface may include an audio device, such as an external speaker system, an external display device such as a display screen, or an input device (e.g., a remote-control device interfaced with the user interface directly or through an I/O controller module). In some cases, the user interface may be a graphical user interface. In some cases, the graphical user interface is provided by retrieval apparatus 115.

According to some aspects, retrieval apparatus 115 includes a computer implemented network. In some embodiments, the computer implemented network includes a machine learning model (such as the machine learning model described with reference to FIG. 2). Additionally, in some embodiments, retrieval apparatus 115 communicates with user device 110 and database 125 via cloud 120.

In some cases, retrieval apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Retrieval apparatus 115 is an example of, or includes aspects of, the corresponding element described with reference to FIGS. 2-4 and 9. Further detail regarding the architecture of retrieval apparatus 115 is provided with reference to FIGS. 2-4. Further detail regarding a process for cross-modal retrieval is provided with reference to FIGS. 5-7. Further detail regarding a process for training the machine learning model is provided with reference to FIGS. 8-9.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if the server has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, retrieval apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to retrieval apparatus 115 and communicates with retrieval apparatus 115 via cloud 120. According to some aspects, database 125 is included in retrieval apparatus 115.

In some cases, database 125 is configured to store, for example, a query, a sequence of token embeddings, a query embedding, an audio sample, a sequence of audio token embeddings, an audio sample embedding, an audio query, a sequence of audio query token embeddings, an audio query embedding, a response, an additional response, a video, an image, timestamp information, any other information generated or received by retrieval apparatus 115, or a combination thereof.

FIG. 2 shows an example of a retrieval apparatus 200 according to aspects of the present disclosure. Retrieval apparatus 200 is an example of, or includes aspects of, the corresponding element described with reference to FIGS. 1, 3-4, and 9. In one aspect, retrieval apparatus 200 includes processor unit 205, memory unit 210, machine learning model 215, response component 240, and training component 245. In one aspect, machine learning model 215 includes query encoder network 220, query projection network 225, audio encoder network 230, and audio projection network 235.

Processor unit 205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In some cases, processor unit 205 is configured to operate a memory array using a memory controller. In other cases, a memory controller is integrated into processor unit 205. In some cases, processor unit 205 is configured to execute computer-readable instructions stored in memory unit 210 to perform various functions. In some aspects, processor unit 205 includes special-purpose components for modem processing, baseband processing, digital signal processing, or transmission processing.

Memory unit 210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor of processor unit 205 to perform various functions described herein. In some cases, memory unit 210 includes a basic input/output system (BIOS) that controls basic hardware or software operations, such as an interaction with peripheral components or devices. In some cases, memory unit 210 includes a memory controller that operates memory cells of memory unit 210. For example, the memory controller may include a row decoder, column decoder, or both. In some cases, memory cells within memory unit 210 store information in the form of a logical state.

In some cases, memory unit 210 stores parameters of machine learning model 215. In some cases, memory unit 210 stores query encoding parameters of query encoder network 220. In some cases, memory unit 210 stores query projection parameters of query projection network 225. In some cases, memory unit 210 stores audio encoding parameters of audio encoder network 230. In some cases, memory unit 210 stores audio projection parameters of audio projection network 235.

According to some aspects, retrieval apparatus 200 obtains a query describing a sound using a query modality other than a sound modality. For example, in some cases, one or more processors of processor unit 205 implement an instruction stored in memory of memory unit 210 to obtain the query describing the sound using the query modality other than the sound modality. In some cases, the query modality comprises a text modality. In some cases, the query comprises a natural language phrase. In some examples, retrieval apparatus 115 receives an audio query. For example, in some cases, one or more processors of processor unit 205 implement an instruction stored in memory of memory unit 210 to receive the audio query.

In one aspect, machine learning model 215 includes query encoder network 220, query projection network 225, audio encoder network 230, and audio projection network 235.

According to some aspects, machine learning model 215 comprises one or more artificial neural networks (ANNs). An ANN is a hardware or a software component that includes a number of connected nodes (i.e., artificial neurons) that loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the neural network. Hidden representations are machine-readable data representations of an input that are learned from a neural network's hidden layers and are produced by the output layer. As the neural network's understanding of the input improves as the neural network is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the inputs. The initial layer is known as the input layer and the last layer is known as the output layer. In some cases, signals traverse certain layers multiple times.

According to some aspects, machine learning model 215 is implemented as software stored in memory unit 210 and executable by processor unit 205, as firmware, as one or more hardware circuits, or as a combination thereof. According to some aspects, machine learning model 215 comprises machine learning model parameters stored in memory unit 210.

According to some aspects, query encoder network 220 is configured to generate a sequence of token embeddings based on the query. In some cases, the sequence of token embeddings is encoded in a query embedding space. According to some aspects, query encoder network 220 is configured to generate a sequence of corresponding sample token embeddings based on a corresponding sample that corresponds to an audio sample. In some cases, the sequence of corresponding sample token embeddings is encoded in the query embedding space. According to some aspects, query encoder network 220 is configured to generate a sequence of candidate token embeddings based on a candidate response. In some cases, the sequence of candidate token embeddings is encoded in the query embedding space.

According to some aspects, query encoder network 220 comprises an ANN configured to generate an output of token embeddings in a query modality based on an input. For example, in some cases, query encoder network 220 is implemented a text encoder network configured to generate an output of token embeddings based on a text input. In some cases, query encoder network 220 comprises a BERT model, as a ROBERTa model, or as a large model variation of ROBERTa.

BERT is a transformer-based model that is used for natural language processing and for processing other forms of ordered data. In some examples, BERT is used as a language representation model, and is configured to pretrain deep bidirectional representations from unlabeled text by jointly conditioning on both left and right context in all layers. As a result, the pre-trained BERT model can be fine-tuned with an additional output layer to create network models for tasks such as question answering and language inference.

BERT is a bi-directional model that takes into account both the context to the left and right of a given word when processing text. This allows BERT to better understand the relationships between words and the corresponding meanings in a given context. BERT can also be fine-tuned for specific tasks by adding additional output layers on top of the pre-trained model. This allows BERT to be tailored to a specific task, such as question answering or language inference, by learning task-specific features from labeled data.

ROBERTa is a transformer-based model similar to BERT but further comprises modified key hyperparameters, omits a next-sentence pretraining objective, and can be trained with larger mini-batches and learning rates. In some cases, ROBERTa uses dynamic masking during training. In some cases, the large model variation of ROBERTa provides an increased capacity for language understanding.

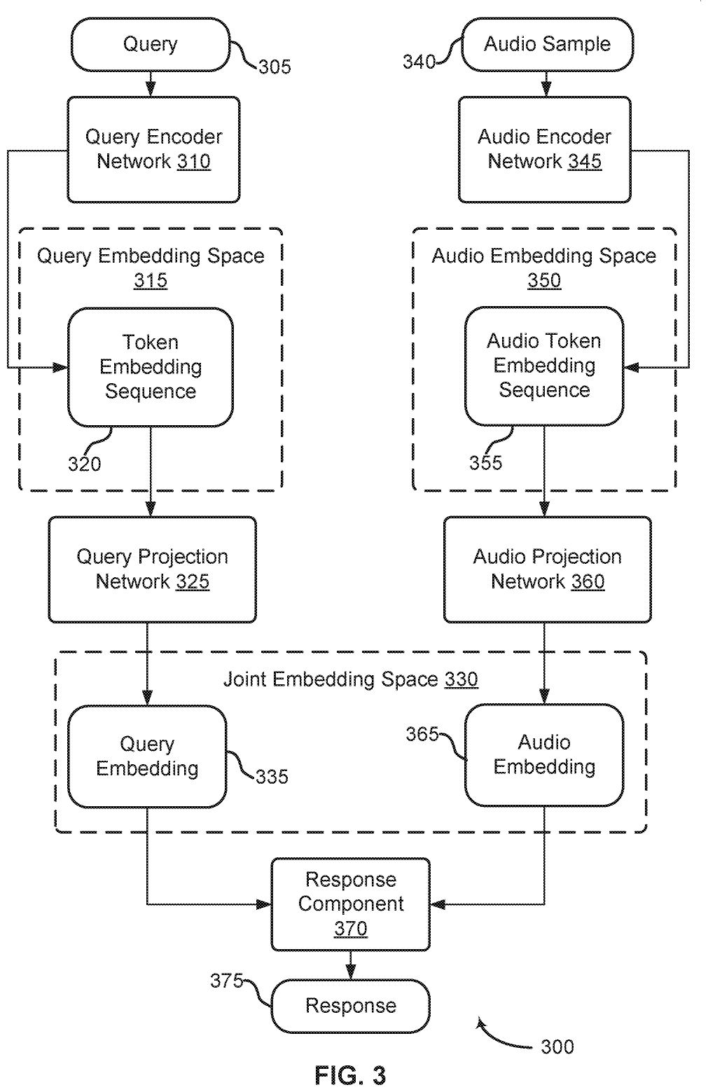

Query encoder network 220 is an example of, or includes aspects of, the corresponding element described with reference to FIGS. 3, 4, and 9. According to some aspects, query encoder network 220 is implemented as one or more hardware circuits, as firmware, as software stored in memory of memory unit 210 and executed by a processor of processor unit 205, or as a combination thereof. In some cases, query encoder network 220 is implemented as query encoding parameters stored in memory unit 210.

According to some aspects, query projection network 225 is configured to encode the sequence of token embeddings to obtain a query embedding in a joint embedding space. In some cases, the joint embedding space is for the query modality and the sound modality. According to some aspects, query projection network 225 is configured to encode the sequence of corresponding sample token embeddings to obtain a corresponding sample embedding in the joint embedding space. According to some aspects, query projection network 225 is configured to encode the sequence of candidate sample token embeddings to obtain a candidate embedding in the joint embedding space.

According to some aspects, query projection network 225 comprises an ANN that includes one or more self-attention layers (e.g., one or more first self-attention layers). In the machine learning field, an attention mechanism is a method of placing differing levels of importance on different elements of an input. Calculating attention may involve three basic steps. First, a similarity between query and key vectors obtained from the input is computed to generate attention weights. Similarity functions used for this process can include dot product, splice, detector, and the like. Next, a softmax function is used to normalize the attention weights. Finally, the attention weights are weighed together with the corresponding values. In some cases, the attention mechanism uses parameters called a query, a key, and a value. The term “self-attention” refers to a machine learning process in which representations of the input interact with each other to determine attention weights for the input. Self-attention can be distinguished from other attention models because the attention weights are determined at least in part by the input itself.

According to some aspects, query projection network 225 comprises a transformer. In some cases, a transformer is a deep learning ANN that adopts a mechanism of self-attention by differentially weighting a significance of each part of an input to the transformer (including in some cases a recursive output of the transformer). In some cases, a transformer processes sequential input data, such as natural language or a sequence of token embeddings. In some cases, the self-attention mechanism provides context for any position in the input sequence, thereby allowing for increased parallelization and reduced training time. For example, if the input data is a natural language sentence, the transformer might not process one word at a time.

In some cases, a transformer transforms one sequence into another sequence using an encoder and a decoder. The encoder and the decoder can include modules that can be stacked on top of each other multiple times. In some cases, the modules comprise multi-head attention and feed forward layers. In some cases, the encoder inputs are embedded as vectors in an n-dimensional space. In some cases, positional encoding of different tokens (for example, an assignment for every part of a sequence to a relative position) is added to the embedded representation (e.g., the n-dimensional vector) of each token.

In some examples, a transformer uses a self-attention mechanism to iteratively determine the importance of parts of the input sequence. In some cases, the attention mechanism involves a query, keys, and values denoted by Q, K, and V, respectively. In some cases, Q represents a matrix that contains the query (e.g., a vector representation of one word in the sequence), K represents the keys (e.g., vector representations of all the words in the sequence), and V represents the values (e.g., the vector representations of all the words in the sequence). In some cases, for the multi-head attention modules of the encoder and the decoder, V comprises a same word sequence as Q. However, for an attention module that takes into account the sequences for the encoder and the decoder, V is different from a sequence represented by Q. In some cases, values in V are multiplied and summed with attention weights.

In some cases, a transformer uses the self-attention mechanism to process sequences of data. In some cases, the self-attention mechanism allows the model to weigh the importance of each element in the sequence when making predictions.

In some cases, a transformer includes one or more feedforward ANNs to process the data after the application of the self-attention mechanism to allow the transformer to make predictions based on the sequence of data. In some cases, a transformer includes layer normalization, which normalizes outputs of the self-attention mechanism and the feedforward neural network. In some cases, a transformer includes positional encoding to indicate a position of each element in a sequence.

In some cases, query projection network 225 comprises a transformer comprising one or more (e.g., two) layers. In some cases, query projection network 225 comprises a transformer comprising one or more (e.g., two) heads.

According to some aspects, query projection network 225 comprises a single-layer perceptron (e.g., a feed-forward ANN based on a threshold transfer function). In some cases, when query projection network 225 comprises a single-layer perceptron, a size of machine learning model 215 is reduced, allowing for greater processing speed.

According to some aspects, query projection network 225 comprises a recurrent neural network (RNN). In some cases, an RNN is a class of ANN in which connections between nodes form a directed graph along an ordered (i.e., a temporal) sequence, allowing the RNN to model temporally dynamic behavior such as predicting what element should come next in a sequence. Thus, an RNN is suitable for tasks that involve ordered sequences. In some cases, an RNN includes a finite impulse recurrent network (characterized by nodes forming a directed acyclic graph) or an infinite impulse recurrent network (characterized by nodes forming a directed cyclic graph).

Query projection network 225 is an example of, or includes aspects of, the corresponding element described with reference to FIGS. 3, 4, and 9. According to some aspects, query projection network 225 is implemented as one or more hardware circuits, as firmware, as software stored in memory of memory unit 210 and executed by a processor of processor unit 205, or as a combination thereof. In some cases, query projection network 225 is implemented as query projection parameters stored in memory unit 210.

According to some aspects, audio encoder network 230 is configured to generate a sequence of audio token embeddings (e.g., a sequence of token embeddings for an audio sample) based on the audio sample. In some cases, the sequence of audio token embeddings is encoded in an audio embedding space. According to some aspects, audio encoder network 230 is configured to generate a sequence of audio token embeddings based on an audio query. In some cases, the sequence of audio embeddings is encoded in an audio embedding space.

According to some aspects, audio encoder network 230 comprises an ANN configured to generate an output of audio token embeddings in a sound modality based on an input. For example, in some cases, audio encoder network 230 comprises a residual neural network (ResNet). In some cases, a ResNet is an ANN comprising skip connections for bypassing one or more layers of the ResNet. In some cases, audio encoder network 230 comprises a ResNet38 model. In some cases, the ResNet38 model comprises pre-trained weights from a PANN (pretrained audio neural network) comprising one or more convolutional neural network (CNN) layers.

A CNN is a class of ANN that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that the filters activate when the filters detect a particular feature within the input.

Audio encoder network 230 is an example of, or includes aspects of, the corresponding element described with reference to FIGS. 3, 4, and 9. According to some aspects, audio encoder network 230 is implemented as one or more hardware circuits, as firmware, as software stored in memory of memory unit 210 and executed by a processor of processor unit 205, or as a combination thereof. In some cases, audio encoder network 230 is implemented as audio encoding parameters stored in memory unit 210.

According to some aspects, audio projection network 235 is configured to encode the sequence of audio token embeddings to obtain an audio embedding in the joint embedding space. According to some aspects, audio projection network 235 is configured to encode the sequence of audio token embeddings to obtain an audio query embedding in the joint embedding space.

According to some aspects, audio projection network 235 includes one or more second self-attention layers (e.g., one or more self-attention layers employing a self-attention mechanism as described herein). According to some aspects, audio projection network 235 comprises a transformer. According to some aspects, audio projection network 235 comprises a transformer comprising one or more (e.g., two) layers. According to some aspects, audio projection network 235 comprises a transformer comprising one or more (e.g., two) heads.

According to some aspects, audio projection network 235 comprises a single-layer perceptron. In some cases, when audio projection network 235 comprises a single-layer perceptron, a size of machine learning model 215 is reduced, allowing for greater processing speed. According to some aspects, audio projection network 235 comprises an RNN.

Audio projection network 235 is an example of, or includes aspects of, the corresponding element described with reference to FIGS. 3, 4, and 9. According to some aspects, audio projection network 235 is implemented as one or more hardware circuits, as firmware, as software stored in memory of memory unit 210 and executed by a processor of processor unit 205, or as a combination thereof. In some cases, audio projection network 235 is implemented as audio projection parameters stored in memory unit 210.

According to some aspects, response component 240 provides a response including the audio sample based on the query embedding, where the audio sample includes the sound. In some cases, the response comprises a video sample comprising the audio sample.

In some examples, response component 240 compares the query embedding and the audio embedding, where the response is provided based on the comparison. In some examples, response component 240 provides the additional response to the audio query, where the additional response includes the query modality.

In some examples, response component 240 identifies timestamp information for the audio sample. In some examples, response component 240 identifies an additional audio sample based on the timestamp information. In some cases, response component 240 identifies the video sample based on the timestamp information

According to some aspects, response component 240 is configured to provide a response including an audio sample based on the query embedding, wherein the audio sample includes the sound.

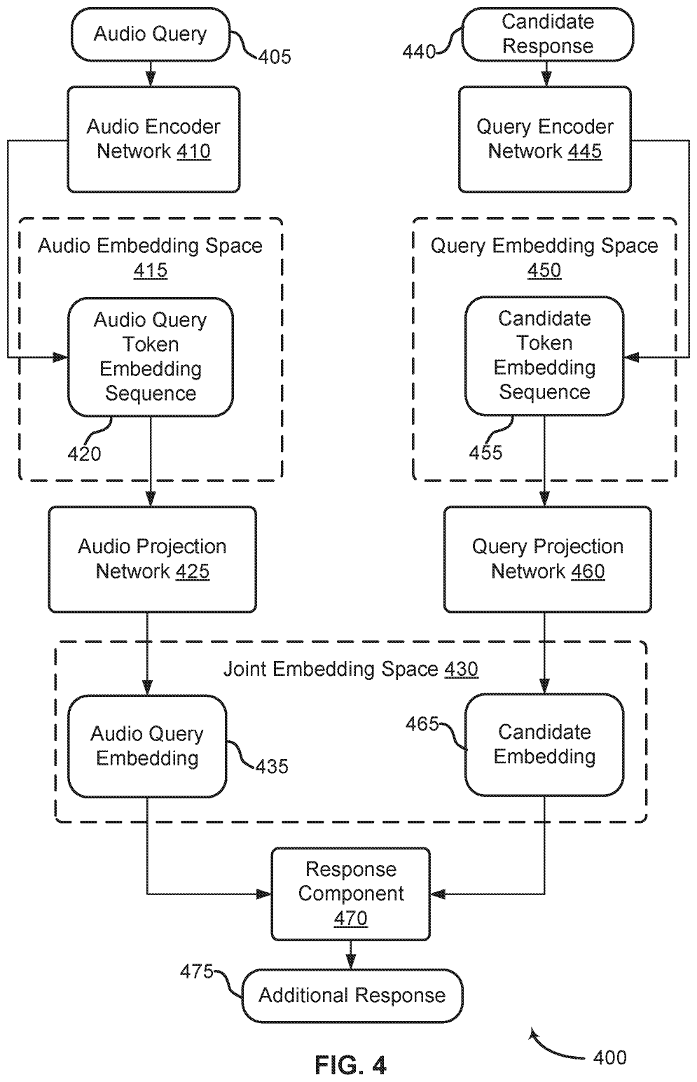

Response component 240 is an example of, or includes aspects of, the corresponding element described with reference to FIGS. 3 and 4. According to some aspects, response component 240 is implemented as one or more hardware circuits, as firmware, as software stored in memory of memory unit 210 and executed by a processor of processor unit 205, or as a combination thereof.

According to some aspects, training component 245 identifies a training dataset including an audio sample in a sound modality and a corresponding sample in a corresponding sample modality other than the sound modality. In some examples, training component 245 trains query projection network 225 based on the audio embedding and the corresponding sample embedding.

In some examples, training component 245 trains the audio projection network 235 based on the audio embedding and the corresponding sample embedding. In some examples, training component 245 fine-tunes query encoder network 220 based on the audio embedding and the corresponding sample embedding. In some examples, training component 245 fine-tunes audio encoder network 230 based on the audio embedding and the corresponding sample embedding.

In some examples, training component 245 computes a contrastive loss based on the audio embedding and the corresponding sample embedding. In some examples, training component 245 updates parameters of query projection network 225 based on the contrastive loss. In some examples, training component 245 identifies metadata corresponding to the audio sample. In some examples, training component 245 combines the metadata with a template to obtain the corresponding sample.

In some examples, training component 245 identifies a pair of additional audio samples in the sound modality and a pair of additional corresponding samples in the corresponding sample modality. In some examples, training component 245 concatenates the pair of additional audio samples to obtain the audio sample. In some examples, training component 245 concatenates the pair of additional corresponding samples to obtain the corresponding sample. In some aspects, the corresponding sample includes a prepositional phrase.

According to some aspects, training component 245 is configured to identify a training dataset including a training audio sample in the sound modality and a corresponding sample in the query modality and to train query projection network 225 based on a training audio embedding of the training audio sample and a training sample embedding of the training sample.

According to some aspects, training component 245 is implemented as one or more hardware circuits, as firmware, as software stored in memory of memory unit 210 and executed by a processor of processor unit 205, or as a combination thereof.

FIG. 3 shows an example of query-based audio retrieval according to aspects of the present disclosure. The example shown includes retrieval apparatus 300, query 305, query encoder network 310, query embedding space 315, token embedding sequence 320, query projection network 325, joint embedding space 330, query embedding 335, audio sample 340, audio encoder network 345, audio embedding space 350, audio token embedding sequence 355, audio projection network 360, audio embedding 365, response component 370, and response 375.

Retrieval apparatus 300 is an example of, or includes aspects of, the corresponding element described with reference to FIGS. 1-2, 4, and 9. Query encoder network 310 is an example of, or includes aspects of, the corresponding element described with reference to FIGS. 2, 4, and 9. Query projection network 325 is an example of, or includes aspects of, the corresponding element described with reference to FIGS. 2, 4, and 9. Audio encoder network 345 is an example of, or includes aspects of, the corresponding element described with reference to FIGS. 2, 4, and 9. Audio projection network 360 is an example of, or includes aspects of, the corresponding element described with reference to FIGS. 2, 4, and 9. Response component 370 is an example of, or includes aspects of, the corresponding element described with reference to FIGS. 2 and 4.

Query 305 is an example of, or includes aspects of, the corresponding element described with reference to FIG. 9. Audio sample 340 is an example of, or includes aspects of, the corresponding element described with reference to FIG. 9.

Query embedding space 315 is an example of, or includes aspects of, the corresponding element described with reference to FIG. 4. Joint embedding space 330 is an example of, or includes aspects of, the corresponding element described with reference to FIG. 4. Audio embedding space 350 is an example of, or includes aspects of, the corresponding element described with reference to FIG. 4.

Referring to FIG. 3, query encoder network 310 receives query 305 (for example, from a user, such as a user as described with reference to FIG. 1). In some cases, query encoder network 310 generates token embedding sequence 320 (e.g., a sequence of token embeddings) in query embedding space 315 based on query 305. In some cases, query projection network 325 receives token embedding sequence 320 and generates query embedding 335 in joint embedding space 330 based on token embedding sequence 320.

In some cases, audio encoder network 345 receives audio sample 340 (e.g., from a user, or by retrieving audio sample 340 from a database, such as the database as described with reference to FIG. 1, or from another source) and generates audio token embedding sequence 355 (e.g., a sequence of audio token embeddings) in audio embedding space 350 based on audio sample 340. In some cases, audio projection network 360 receives audio token embedding sequence 355 and generates audio embedding 365 in joint embedding space 330 based on audio token embedding sequence 355. In some cases, audio projection network 360 provides audio embedding 365 to the database.

In some cases, response component 370 receives query embedding 335 from query projection network 325. In some cases, response component 370 retrieves audio embedding 365 from the database in response to receiving query embedding 335. In some cases, response component 370 determines that audio embedding 365 corresponds to query embedding 335 (e.g., via a similarity metric such as a cosine similarity or Euclidean distance between audio embedding 365 and query embedding 335). In some cases, in response to the determination, response component 370 generates response 375 and provides response 375 to the user (e.g., via a user device, such as the user device as described with reference to FIG. 1). In some cases, response 375 comprises audio sample 340 corresponding to audio embedding 365.

In some cases, response 375 comprises a video corresponding to audio sample 340. In some cases, the video is a video file comprising the audio sample 340. In some cases, response component 370 retrieves the video from the database. In some cases, timestamp information of the video corresponds to timestamp information of the audio sample 340. In some cases, the correspondence between the audio sample and the video is stored in the database.

FIG. 4 shows an example of audio-based response retrieval according to aspects of the present disclosure. The example shown includes retrieval apparatus 400, audio query 405, audio encoder network 410, audio embedding space 415, audio query token embedding sequence 420, audio projection network 425, joint embedding space 430, audio query embedding 435, candidate response 440, query encoder network 445, query embedding space 450, candidate token embedding sequence 455, query projection network 460, candidate embedding 465, response component 470, and additional response 475.

Retrieval apparatus 400 is an example of, or includes aspects of, the corresponding element described with reference to FIGS. 1-2, 3, and 9. Audio encoder network 410 is an example of, or includes aspects of, the corresponding element described with reference to FIGS. 2, 3, and 9.

Audio projection network 425 is an example of, or includes aspects of, the corresponding element described with reference to FIGS. 2, 3, and 9. Query encoder network 445 is an example of, or includes aspects of, the corresponding element described with reference to FIGS. 2, 3, and 9. Query projection network 460 is an example of, or includes aspects of, the corresponding element described with reference to FIGS. 2, 3, and 9. Response component 470 is an example of, or includes aspects of, the corresponding element described with reference to FIGS. 2 and 3.

Audio embedding space 415 is an example of, or includes aspects of, the corresponding element described with reference to FIG. 3. Joint embedding space 430 is an example of, or includes aspects of, the corresponding element described with reference to FIG. 3. Query embedding space 450 is an example of, or includes aspects of, the corresponding element described with reference to FIG. 3.

Referring to FIG. 4, audio encoder network 410 receives audio query 405 (for example, from a user, such as a user as described with reference to FIG. 1). In some cases, audio encoder network 410 generates audio query token embedding sequence 420 (e.g., a sequence of token embeddings for the audio query) in audio embedding space 415 based on audio query 405. In some cases, audio projection network 425 receives audio query token embedding sequence 420 and generates audio query embedding 435 in joint embedding space 430 based on audio query token embedding sequence 420.

In some cases, query encoder network 445 receives candidate response 440 (e.g., from a user, or by retrieving candidate response 440 from a database, such as the database as described with reference to FIG. 1, or from another source) and generates candidate token embedding sequence 455 (e.g., a sequence of candidate token embeddings) in query embedding space 450 based on candidate response 440. In some cases, query projection network 460 receives candidate token embedding sequence 455 and generates candidate embedding 465 in joint embedding space 430 based on candidate token embedding sequence 455. In some cases, query projection network 460 provides candidate embedding 465 to the database.

In some cases, response component 470 receives audio query embedding 435 from audio projection network 425. In some cases, response component 470 retrieves candidate embedding 465 from the database in response to receiving audio query embedding 435. In some cases, response component 470 determines that candidate embedding 465 corresponds to audio query embedding 435 (e.g., via a similarity metric such as a cosine similarity or Euclidean distance between candidate embedding 465 and audio query embedding 435). In some cases, in response to the determination, response component 470 provides additional response 475 to the user (e.g., via a user device, such as the user device as described with reference to FIG. 1). In some cases, additional response 475 comprises candidate response 440 corresponding to candidate embedding 465.

### Cross-Modal Retrieval

A method for cross-modal retrieval is described with reference to FIGS. 5-7. One or more aspects of the method include obtaining a query describing a sound using a query modality other than a sound modality; encoding the query to obtain a query embedding using a query encoder network for the query modality and a query projection network, wherein the query projection network includes a self-attention layer, and wherein the query embedding is in a joint embedding space for the query modality and the sound modality; and providing a response including an audio sample based on the query embedding, wherein the audio sample includes the sound.

In some cases, the query modality comprises a text modality. In some cases, the query comprises a natural language phrase.

In some cases, the response includes a video sample including the audio sample. Some examples of the method further include identifying timestamp information for the audio sample. Some examples further include identifying the video sample based on the timestamp information.

Some examples of the method further include encoding the audio sample to obtain an audio embedding using an audio encoder network for the sound modality and an audio projection network, wherein the audio projection network includes a second self-attention layer, and wherein the audio embedding is in the joint embedding space. Some examples further include comparing the query embedding and the audio embedding, wherein the response is provided based on the comparison.

Some examples of the method further include receiving an audio query. Some examples further include encoding the audio query to obtain an audio query embedding using an audio encoder network for the sound modality and an audio query projection network, wherein the audio query projection network includes a second self-attention layer, and wherein the audio query embedding is in the joint embedding space. Some examples further include providing an additional response to the audio query, wherein the additional response comprises the query modality.

Some examples of the method further include generating a sequence of token embeddings based on the query using the query encoder network, wherein the query projection network takes the sequence of token embeddings as an input. Some examples of the method further include identifying timestamp information for the audio sample. Some examples further include identifying an additional audio sample based on the timestamp information.

FIG. 5 shows an example of a method 500 for cross-modal retrieval according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 5, a user (such as the user described with reference to FIG. 1) uses the system (such as the cross-modal retrieval system described with reference to FIG. 1) to retrieve a response including an audio sample based on a query. For example, in some cases, the query is a text query including a natural language phrase (e.g., “a cat meowing in the forest”). In some cases, the query is an image in an image modality. In some cases, the query is a video in a video modality. In some cases, the system encodes the query in a joint embedding space. In some cases, the system matches the encoded query to an audio embedding of the audio sample in the joint embedding space.

In some cases, by encoding the query and the audio sample in the joint embedding space, an accuracy of the match is increased over an accuracy of conventional cross-modal retrieval systems. In some cases, by encoding the query and the audio sample in the joint embedding space, a more syntactically or grammatically complex query can be used than conventional cross-modal retrieval systems are capable of processing. In some cases, the system provides the response including the audio sample corresponding to the matching audio embedding to the user.

At operation 505, the system provides a query in a query modality. In some cases, the operations of this step refer to, or may be performed by, a user as described with reference to FIG. 1. For example, in some cases, the user provides the query to the system via a user device (such as the user device described with reference to FIG. 1). In some cases, the user provides the query via a graphical user interface displayed on the user device (for example, via a text entry field or a file upload). In some cases, the system provides the graphical user interface on the user device.

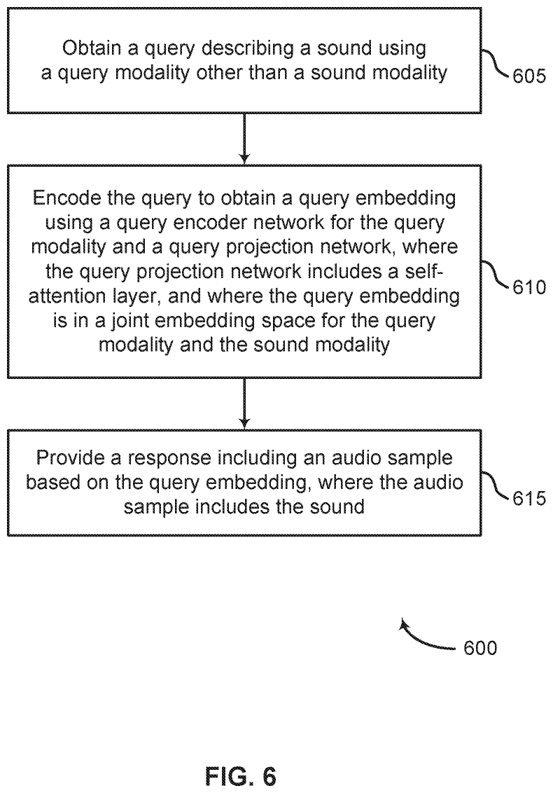

At operation 510, the system retrieves a response in a sound modality based on the query. In some cases, the operations of this step refer to, or may be performed by, a retrieval apparatus as described with reference to FIGS. 1-4 and 9. For example, in some cases, the retrieval apparatus retrieves an audio sample in a sound modality based on the query as described with reference to FIG. 6 and includes the audio sample in the response.

At operation 515, the system provides the response to the user. In some cases, the operations of this step refer to, or may be performed by, a retrieval apparatus as described with reference to FIGS. 1-4 and 9. For example, in some cases, the retrieval apparatus provides the response to the user via the user device. In some cases, the retrieval apparatus provides the response to the user via the graphical user provided on the user device.

FIG. 6 shows an example of a method 600 for providing a response to a query according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 6, the system (such as the cross-modal retrieval system described with reference to FIG. 1) performs cross-modal retrieval by matching an embedding of a query in a joint embedding space to an audio embedding in the joint embedding space and providing a response including an audio sample corresponding to the audio embedding. In some cases, the query is provided in a query modality. In some cases, the audio sample is provided in a sound modality.

As used herein, a “query modality” refers to a non-audio class of information. For example, in some cases, a query modality is a text modality corresponding to text information, an image modality corresponding to image information, or a video modality corresponding to video information. As used herein, a “sound modality” refers to a class of audio information. As used herein a “sound” can include a plurality of sounds.

As used herein, a “joint embedding space” refers to a relatively low-dimensional space into which high-dimensional vectors can be translated. In some cases, the joint embedding space allows semantic information captured by the query embedding and the audio embedding to be compared based on a distance between the query embedding and the audio embedding in the joint embedding space. Therefore, in some cases, the joint embedding space allows the cross-modal retrieval system to determine semantically similar information that originates in different modalities, which allows the cross-modal retrieval system to determine that a query corresponds to an audio sample, and in some cases, that an audio query corresponds to a candidate response in a non-sound modality.

At operation 605, the system obtains a query describing a sound using a query modality other than a sound modality. In some cases, the operations of this step refer to, or may be performed by, a retrieval apparatus as described with reference to FIGS. 1-4 and 9. For example, in some cases, a user (such as the user described with reference to FIG. 1) provides the query to the retrieval apparatus (for example, via a user device as described with reference to FIG. 1). In some cases, the query modality is a text modality and the query comprises text. In some cases, the text comprises a natural language description of the sound. In some cases, the query modality is an image modality or a video modality and the query is a visual depiction of the sound.

At operation 610, the system encodes the query to obtain a query embedding using a query encoder network for the query modality and a query projection network, where the query projection network includes a self-attention layer, and where the query embedding is in a joint embedding space for the query modality and the sound modality. In some cases, the operations of this step refer to, or may be performed by, a query encoder network and a query projection network as described with reference to FIGS. 2-4, and 9.

For example, in some cases, the query encoder network generates a sequence of token embeddings based on the query. For example, in some cases, a token embedding in the sequence of token embeddings can correspond to a word included in the query. In some cases, a relative position of a token embedding in the sequence corresponds to a relative position of a word in the query. In some cases, the sequence of token embeddings comprises a classification ([CLS]) token embedding in an initial position of the sequence. In some cases, the [CLS] token summarizes the sequence of token embeddings. In some cases, the sequence of token embeddings is in a query embedding space corresponding to the query modality. In some cases, a token embedding of the sequence of token embeddings comprises a 2,048-dimensional vector.

In some cases, a query projection network encodes the sequence of token embeddings to obtain the query embedding in the joint embedding space. For example, in some cases, the query projection network aggregates the sequence of token embeddings and projects the aggregated sequence of token embeddings into the joint embedding space (for example, using positional encoding) to obtain the query embedding. In some cases, the query projection network applies the one or more self-attention layers to the sequence of token embeddings to obtain the query embedding, thereby modeling sequential ordering for the query in a more effective manner than conventional cross-modal retrieval systems. In some cases, by modeling sequential ordering for the query to obtain the query embedding, the cross-modal retrieval system can accurately retrieve an audio sample including a complex sound (e.g., a sound including an ordered sequence of sounds) described by the query.

In some cases, the query projection network obtains a query embedding for each token embedding in the sequence of token embeddings. In some cases, the query embedding includes an embedding of the [CLS] token embedding. In some cases, the query embedding comprises a 1,024-dimensional vector.

At operation 615, the system provides a response including an audio sample based on the query embedding, where the audio sample includes the sound. In some cases, the operations of this step refer to, or may be performed by, a response component as described with reference to FIGS. 2-4.

For example, in some cases, the response component compares the query embedding to an audio embedding of the audio sample, where the audio embedding is in the joint embedding space. In some cases, the response component compares the query embedding to the audio embedding by determining a similarity of the query embedding and the audio embedding (for example, via a similarity metric such as a cosine similarity or a Euclidean distance).

In some cases, an audio encoder network (such as the audio encoder network described with reference to FIGS. 2-4 and 9) retrieves the audio sample (for example, from a database such as the database described with reference to FIG. 1) and generates a sequence of audio token embeddings based on the audio sample. In some cases, the sequence of audio token embeddings includes an audio [CLS] token embedding in an initial position of the sequence. In some cases, the audio [CLS] token summarizes the sequence of audio token embeddings. In some cases, an audio token embedding in the sequence of audio token embeddings corresponds to a sub-sample included in the audio sample, where the sub-sample corresponds to a discrete period of time. In some cases, the sequence of audio token embeddings includes timestamp information of the audio sample. In some cases, the discrete period of time corresponds to the timestamp information.

In some cases, an audio projection network (such as the audio projection network described with reference to FIGS. 2-4 and 9) encodes the sequence of audio token embeddings to obtain the audio embedding in the joint embedding space. For example, in some cases, the audio projection network aggregates the sequence of audio token embeddings and projects the aggregated sequence of audio token embeddings into the joint embedding space (for example, using positional encoding) to obtain the audio embedding. In some cases, the query projection network applies the one or more self-attention layers to the sequence of audio token embeddings to obtain the audio embedding, thereby modeling sequential sound ordering for the audio sample more effectively than conventional cross-modal retrieval systems. In some cases, by modeling sequential ordering for the audio sample to obtain the audio embedding, the cross-modal retrieval system can accurately retrieve an audio sample including a complex sound (e.g., a sound including an ordered sequence of sounds) described by a query in a non-sound modality.

In some cases, the audio projection network obtains an audio embedding for each audio token embedding in the sequence of audio token embeddings. In some cases, the audio embedding includes an embedding of the audio [CLS] token embedding. In some cases, the audio embedding comprises a 1,024-dimensional vector.

In some cases, the response component compares the query embedding and the audio embedding by determining a similarity between the query embedding and the audio embedding. For example, in some cases, the response component compares the query embedding and the audio embedding by determining a similarity between the query embedding and the audio embedding via a similarity metric such as a cosine similarity or a Euclidean distance. In some cases, if the similarity metric is respectively greater than a similarity threshold (in the case of, e.g., a cosine similarity) or is respectively less than the similarity threshold (in the case of, e.g., a Euclidean distance), the response component determines that the query embedding matches the audio embedding.

In some cases, in response to the determination, the response component retrieves the audio sample corresponding to the audio embedding (for example, from the database) and includes the audio sample in the response.

In some cases, the response component determines timestamp information for the audio sample based on the timestamp information included in the audio embedding. In some cases, the response component identifies an additional audio sample based on the timestamp information. For example, in some cases, based on the timestamp information, the response component determines that the audio sample is included in a longer audio sample (e.g., the additional audio sample). In some cases, the response component includes the additional audio sample in the response.

In some cases, the response component determines that the audio sample corresponds to a video sample based on the timestamp information for the audio sample. In some cases, the timestamp information for the audio sample corresponds to timestamp information for the video sample. In some cases, a correspondence between the audio sample and the video sample (e.g., via timestamp information for the audio sample and timestamp information for the video sample) is included in a data schema included in a database (such as the database described with reference to FIG. 1). In some cases, the response component determines that the video sample includes the audio sample. In some cases, the audio sample or the additional audio sample is coextensive with the video sample. In some cases, the response component includes the video sample or a portion of the video sample including the audio sample or the additional audio sample in the response.

In some cases, the response component includes a visual representation of timestamp information for the audio sample, the additional audio sample, the video sample, the portion of the video sample, or a combination thereof in the response.

In some cases, the response component provides the response to the user via the user device. In some cases, the response includes the audio sample, the additional audio sample, the video sample, the portion of the video sample, the respective timestamp information, or a combination thereof. In some cases, a graphical user interface of the user device presents the query together with the response.

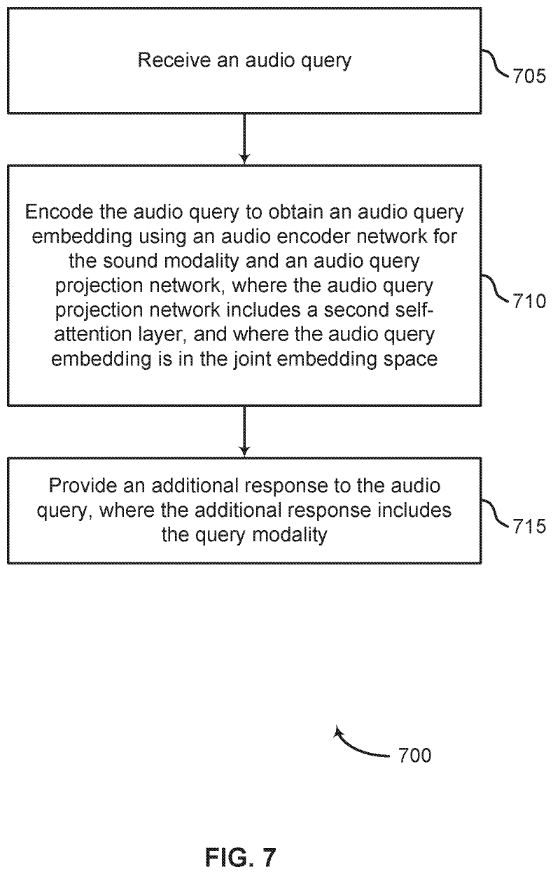

According to some aspects, the retrieval apparatus provides an additional response as described with reference to FIG. 7.

FIG. 7 shows an example of a method 700 for providing an additional response to an audio query according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 7, the system (e.g., a cross-modal retrieval system described with reference to FIG. 1) provides an additional response based on an audio query.

At operation 705, the system receives an audio query. In some cases, the operations of this step refer to, or may be performed by, a retrieval apparatus as described with reference to FIGS. 1 and 2. For example, in some cases, a user (such as the user described with reference to FIG. 1) provides the audio query (for example, a query including a sound) to the retrieval apparatus via a user device (such as the user device described with reference to FIG. 1).

At operation 710, the system encodes the audio query to obtain an audio query embedding using an audio encoder network for the sound modality and an audio query projection network, where the audio query projection network includes one or more second self-attention layers, and where the audio query embedding is in the joint embedding space. In some cases, the operations of this step refer to, or may be performed by, an audio encoder network and an audio projection network as described with reference to FIGS. 2-4, and 9.

For example, in some cases, the audio encoder network generates a sequence of audio query token embeddings based on the audio query. In some cases, the sequence of audio query token embeddings includes an audio query [CLS] token embedding in an initial position of the sequence. In some cases, the audio query [CLS] token embedding summarizes the sequence of audio token embeddings. In some cases, an audio query token embedding in the sequence of audio query token embeddings corresponds to a discrete period of time in the audio query. In some cases, the sequence of audio query token embeddings includes timestamp information of the audio query. In some cases, the discrete period of time corresponds to the timestamp information.

In some cases, the audio projection network encodes the sequence of audio query token embeddings to obtain the audio query embedding in the joint embedding space. For example, in some cases, the audio projection network aggregates the sequence of audio query token embeddings and projects the aggregated sequence of audio token embeddings into the joint embedding space (for example, using positional encoding) to obtain the audio query embedding. In some cases, the audio projection network obtains an audio embedding for each audio query token embedding in the sequence of audio query token embeddings. In some cases, the audio query embedding includes an embedding of the audio [CLS] token embedding. In some cases, the audio query embedding comprises a 1,024-dimensional vector.

At operation 715, the system provides an additional response to the audio query, where the additional response includes the query modality. In some cases, the operations of this step refer to, or may be performed by, a response component as described with reference to FIGS. 2-4.

For example, in some cases, the response component compares the audio query embedding to a candidate embedding of a candidate response, where the candidate embedding is in the joint embedding space. In some cases, the response component compares the audio query embedding to the candidate embedding by determining a similarity of the audio query embedding and the candidate embedding (for example, via a similarity metric such as a cosine similarity or a Euclidean distance).

In some cases, a query encoder network (such as the query encoder network described with reference to FIGS. 2-4 and 9) retrieves a candidate response (for example, from a database such as the database described with reference to FIG. 1). In some cases, the candidate response includes a candidate modality other than a sound modality. For example, in some cases, the candidate modality includes a text modality, an image modality, or a video modality. In some cases, the candidate response comprises text, an image, or a video. In some cases, the user identifies the candidate modality via the user device.

In some cases, the query encoder network generates a sequence of candidate token embeddings based on the candidate response. In some cases, the sequence of candidate token embeddings includes a candidate [CLS] token embedding in an initial position of the sequence. In some cases, the candidate [CLS] token summarizes the sequence of candidate token embeddings. In some cases, a relative position of a token embedding in the sequence of candidate token embeddings corresponds to a relative position of a word in the candidate response. In some cases, the sequence of candidate token embeddings comprises a candidate classification ([CLS]) token embedding in an initial position of the sequence. In some cases, the candidate [CLS] token summarizes the sequence of candidate token embeddings. In some cases, the sequence of candidate token embeddings is in a query embedding space corresponding to the candidate modality. In some cases, a candidate token embedding of the sequence of candidate token embeddings comprises a 2,048-dimensional vector.

In some cases, a query projection network (such as the query projection network described with reference to FIGS. 2-4 and 9) encodes the sequence of candidate token embeddings to obtain the candidate embedding in the joint embedding space. For example, in some cases, the query projection network aggregates the sequence of candidate token embeddings and projects the aggregated sequence of candidate token embeddings into the joint embedding space (for example, using positional encoding) to obtain the candidate embedding. In some cases, the query projection network obtains a candidate embedding for each candidate token embedding in the sequence of candidate token embeddings. In some cases, the candidate embedding includes an embedding of the candidate [CLS] token embedding. In some cases, the candidate embedding comprises a 1,024-dimensional vector.

In some cases, the response component compares the audio query embedding and the candidate embedding by determining a similarity between the audio query embedding and the candidate embedding. For example, in some cases, the response component compares the audio query embedding and the candidate embedding by determining a similarity between the audio query embedding and the candidate embedding via a similarity metric such as a cosine similarity or a Euclidean distance. In some cases, if the similarity metric is respectively greater than an additional similarity threshold (in the case of, e.g., a cosine similarity) or is respectively less than the additional similarity threshold (in the case of, e.g., a Euclidean distance), then the response component determines that the audio query embedding matches the candidate embedding. For example, the response component determines that the audio query matches the candidate response based on the comparison.

In some cases, in response to the determination, the response component retrieves the candidate response corresponding to the candidate embedding (for example, from the database) and includes the candidate response in the additional response.

In some cases, the response component provides the additional response to the user via the user device. In some cases, a graphical user interface of the user device presents the audio query together with the additional response.

### Training

A method for cross-modal retrieval is described with reference to FIGS. 8-9. One or more aspects of the method include identifying a training dataset including an audio sample in a sound modality and a corresponding sample in a corresponding sample modality other than the sound modality; encoding the corresponding sample to obtain a corresponding sample embedding using a query encoder network for the corresponding sample modality and a query projection network, wherein the query projection network includes a first self-attention layer, and wherein the corresponding sample embedding is in a joint embedding space for the corresponding sample modality and the sound modality; encoding the audio sample to obtain an audio embedding using an audio encoder network for the sound modality and an audio projection network, wherein the audio projection network includes a second self-attention layer, and wherein the audio embedding is in the joint embedding space; and training the query projection network based on the audio embedding and the corresponding sample embedding.

Some examples of the method further include training the audio projection network based on the audio embedding and the corresponding sample embedding. Some examples of the method further include fine-tuning the audio encoder network based on the audio embedding and the corresponding sample embedding.

Some examples of the method further include computing a contrastive loss based on the audio embedding and the corresponding sample embedding. Some examples further include updating parameters of the query projection network based on the contrastive loss. Some examples of the method further include identifying metadata corresponding to the audio sample. Some examples further include combining the metadata with a template to obtain the corresponding sample.

Some examples of the method further include identifying a pair of additional audio samples in the sound modality and a pair of additional corresponding samples in the corresponding sample modality. Some examples further include combining the pair of additional audio samples to obtain the audio sample. Some examples further include combining the pair of additional corresponding samples to obtain the corresponding sample. In some aspects, the corresponding sample includes a prepositional phrase.

FIG. 8 shows an example of a method 800 for training a query projection network according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 8, the system (such as the cross-modal retrieval system described with reference to FIG. 1) trains a query projection network based on an audio embedding and a corresponding sample embedding in a joint embedding space.

At operation 805, the system identifies a training dataset including an audio sample in a sound modality and a corresponding sample in a corresponding sample modality other than the sound modality. In some cases, the operations of this step refer to, or may be performed by, a training component as described with reference to FIG. 2.

For example, in some cases, the training component retrieves the training dataset from a database (such as the database described with reference to FIG. 1). In some cases, the corresponding sample includes text (e.g., including a natural language phrase), an image, or a video, and the corresponding sample modality is respectively a text modality, an image modality, or a video modality. In some cases, the corresponding sample includes a description of a sound included in the audio sample.

In some cases, the training component identifies metadata corresponding to the audio sample. In some cases, the metadata is associated with the audio sample via a data schema stored in a database (such as the database described with reference to FIG. 1). In some cases, the metadata is included in a file including the audio sample. In some cases, the training component combines the metadata with a template to obtain the corresponding sample. For example, in some cases, the training component inserts a metadata tag corresponding to the audio sample in a template phrase such as “a sound of [ . . . ]”, “[ . . . ] sound”, “this is a sound of [ . . . ]”, “there is [ . . . ] sound”, etc., to obtain the corresponding sample, where the bracketed ellipses [ . . . ] indicate where in the template phrase the metadata tag is inserted. In some cases, the metadata tag is selected from a comma-separated list. In some cases, the comma-separated list is stored in the database. In some cases, category metadata for the audio sample, sub-category metadata for the audio sample, or a combination thereof is concatenated with the phrase to obtain the corresponding sample.

According to some aspects, the training component identifies a pair of additional audio samples in the sound modality and a pair of additional corresponding samples in the corresponding sample modality. In some cases, the pair of additional audio samples and the pair of additional corresponding samples are stored in the database. In some cases, the training component obtains the pair of additional audio samples by sampling (e.g., extracting) the pair of additional audio samples from one or more other audio samples. In some cases, the training component combines the pair of additional audio samples (for example, by concatenation) to obtain the audio sample. Accordingly, in some cases, the audio sample includes sequential sound events (e.g., sequential sounds).

In some cases, the pair of corresponding samples respectively describe sounds included in the pair of additional audio samples. In some cases, the training component obtains the pair of corresponding samples by combining metadata corresponding to the pair of additional audio samples with templates as described above. In some cases, the training component combines the pair of additional corresponding samples (for example, by concatenation) to obtain the corresponding sample. In some cases, the training component combines the pair of additional corresponding samples with a prepositional phrase to obtain the corresponding sample. For example, in some cases, the corresponding sample includes text such as “< . . . > followed by < . . . >”, “< . . . > and then < . . . >”, “ . . . > before < . . . >”, “< . . . > after < . . . >”, etc., where each of the bracketed ellipses < . . . > represents an additional corresponding sample of the pair of additional corresponding samples. Accordingly, in some cases, the corresponding sample describes sequential sound events (e.g., sequential sounds).

In some cases, the training dataset includes a second audio sample. In some cases, the training component generates the second audio sample by combining a pair of additional second audio samples as described above.

In some cases, the training dataset includes a second sample in the corresponding sample modality. In some cases, the second sample corresponds to the second audio sample. In some cases, the training component generates the second sample based on metadata associated with the second audio sample as described above. In some cases, the training component generates the second sample by combining a pair of additional second samples as described above.

At operation 810, the system encodes the corresponding sample to obtain a corresponding sample embedding using a query encoder network for the corresponding sample modality and a query projection network, where the query projection network includes one or more first self-attention layers, and where the corresponding sample embedding is in a joint embedding space for the corresponding sample modality and the sound modality. In some cases, the operations of this step refer to, or may be performed by, a query encoder network and a query projection network as described with reference to FIGS. 2-4, and 9.

For example, in some cases, in some cases, the query encoder network generates a sequence of corresponding sample token embeddings based on the corresponding sample. For example, in some cases, a corresponding sample token embedding in the sequence of corresponding sample token embeddings can correspond to a word included in the corresponding sample. In some cases, a relative position of a corresponding sample token embedding in the sequence of corresponding sample token embeddings corresponds to a relative position of a word in the corresponding sample. In some cases, the sequence of corresponding sample token embeddings comprises a corresponding sample [CLS] token embedding in an initial position of the sequence of corresponding sample token embeddings. In some cases, the corresponding sample [CLS] token summarizes the sequence of corresponding sample token embeddings. In some cases, the sequence of corresponding sample token embeddings is in a corresponding sample embedding space corresponding to the corresponding sample modality. In some cases, a corresponding sample token embedding of the sequence of corresponding sample token embeddings comprises a 2,048-dimensional vector.

In some cases, the query projection network encodes the sequence of corresponding sample token embeddings to obtain the corresponding sample embedding in the joint embedding space. For example, in some cases, the query projection network aggregates the sequence of corresponding sample token embeddings and projects the aggregated sequence of corresponding sample token embeddings into the joint embedding space (for example, using positional encoding) to obtain the corresponding sample embedding. In some cases, the query projection network obtains a corresponding sample embedding for each corresponding sample token embedding in the sequence of corresponding sample token embeddings. In some cases, the corresponding sample embedding includes an embedding of the corresponding sample [CLS] token embedding. In some cases, the corresponding sample embedding comprises a 1,024-dimensional vector.

In some cases, the system similarly encodes the second sample to obtain a second sample embedding.

At operation 815, the system encodes the audio sample to obtain an audio embedding using an audio encoder network for the sound modality and an audio projection network, where the audio projection network includes one or more second self-attention layers, and where the audio embedding is in the joint embedding space. In some cases, the operations of this step refer to, or may be performed by, an audio encoder network and an audio projection network as described with reference to FIGS. 2-4, and 9. For example, in some cases, the audio encoder network and the audio projection network encode the audio sample to obtain the audio embedding as described with reference to FIG. 6. In some cases, the audio embedding includes the embedding of the audio [CLS] token embedding. In some cases, the system similarly encodes the second audio sample to obtain a second audio sample embedding.

At operation 820, the system trains the query projection network based on the audio embedding and the query embedding. In some cases, the operations of this step refer to, or may be performed by, a training component as described with reference to FIG. 2.

For example, in some cases, the training component computes a contrastive loss based on the audio embedding and the corresponding sample embedding. In some cases, the contrastive loss is a noise contrastive estimation (NCE) loss. In some cases, the contrastive loss is an InfoNCE loss.

Contrastive learning refers to a type of machine learning in which a model is trained using the selection of positive and negative sample pairs. Contrastive learning can be used in either a supervised or an unsupervised (e.g., self-supervised) training context. A loss function for a contrastive learning model can encourage a model to generate similar results for positive sample pairs, and dissimilar results for negative sample pairs.

A loss function refers to a function that impacts how a machine learning model is trained in a supervised learning model. For example, during each training iteration, the output of the model is compared to the known annotation information in the training data. The loss function provides a value (a “loss”) for how close the predicted annotation data is to the actual annotation data. After computing the loss, the parameters of the model are updated accordingly and a new set of predictions are made during the next iteration.

Supervised learning is one of three basic machine learning paradigms, alongside unsupervised learning and reinforcement learning. Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). A supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

In some cases, the training component computes a first similarity (e.g., a cosine similarity, a Euclidean distance, etc.) between the audio embedding and the corresponding sample embedding. In some cases, the training component computes a second similarity (e.g., a cosine similarity, a Euclidean distance, etc.) between the audio embedding and the second sample embedding. In some cases, the training component computes a third similarity (e.g., a cosine similarity, a Euclidean distance, etc.) between the corresponding sample embedding and the second audio sample embedding. In some cases, the training component computes the contrastive loss by summing the first similarity, the second similarity, and the third similarity.

According to some aspects, the training component updates the parameters of the query projection network by backpropagating the contrastive loss through the query projection network. According to some aspects, the training component updates the parameters of the audio projection network by backpropagating the contrastive loss through the audio projection network. According to some aspects, the training component fine-tunes the query encoder network based on the contrastive loss. According to some aspects, the training component fine-tunes the audio encoder network based on the contrastive loss.

An example of data flow in a retrieval apparatus in a training context is described with reference to FIG. 9.

FIG. 9 shows an example of training a query projection network 915 and an audio projection network 930 according to aspects of the present disclosure. The example shown includes retrieval apparatus 900, corresponding sample 905, query encoder network 910, query projection network 915, audio sample 920, audio encoder network 925, and audio projection network 930. The example shown further includes contrastive loss 935.

Retrieval apparatus 900 is an example of, or includes aspects of, the corresponding element described with reference to FIGS. 1-4. corresponding sample 905 is an example of, or includes aspects of, a query described with reference to FIG. 3. Audio sample 920 is an example of, or includes aspects of, the corresponding element described with reference to FIG. 3.

Query encoder network 910 is an example of, or includes aspects of, the corresponding element described with reference to FIGS. 2-4. Query projection network 915 is an example of, or includes aspects of, the corresponding element described with reference to FIGS. 2-4. Audio encoder network 925 is an example of, or includes aspects of, the corresponding element described with reference to FIGS. 2-4. Audio projection network 930 is an example of, or includes aspects of, the corresponding element described with reference to FIGS. 2-4.

Referring to FIG. 9, query encoder network 910 and query projection network 915 generate a corresponding sample embedding of corresponding sample 905 in a joint embedding space as described with reference to FIG. 8, and audio encoder network 925 and audio projection network 930 generate an audio sample embedding of audio sample 920 in the joint embedding space as described with reference to FIG. 8. A training component (such as the training component described with reference to FIG. 2) determines contrastive loss 935 based on the corresponding sample embedding and the audio sample embedding as described with reference to FIG. 8. In some cases, the training component updates the parameters of query projection network 915 based on contrastive loss 935 as described with reference to FIG. 8. In some cases, the training component updates the parameters of audio projection network 930 based on contrastive loss 935 as described with reference to FIG. 8. In some cases, the training component fine-tunes query encoder network 910 based on contrastive loss 935 as described with reference to FIG. 8. In some cases, the training component fine-tunes audio encoder network 925 based on contrastive loss 935 as described with reference to FIG. 8.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for cross-modal retrieval, comprising:
obtaining a query describing a sound using a query modality other than a sound modality;
encoding the query to obtain a query embedding using a query encoder network for the query modality and a query projection network, wherein the query projection network includes a self-attention layer, and wherein the query embedding is in a joint embedding space for the query modality and the sound modality; and
providing a response including an audio sample based on the query embedding, wherein the audio sample includes the sound.

2. The method of claim 1, further comprising:
encoding the audio sample to obtain an audio embedding using an audio encoder network for the sound modality and an audio projection network, wherein the audio projection network includes a second self-attention layer, and wherein the audio embedding is in the joint embedding space; and
comparing the query embedding and the audio embedding, wherein the response is provided based on the comparison.

3. The method of claim 1, wherein:
the query modality comprises a text modality.

4. The method of claim 3, wherein:
the query comprises a natural language phrase.

5. The method of claim 1, further comprising:
receiving an audio query;
encoding the audio query to obtain an audio query embedding using an audio encoder network for the sound modality and an audio query projection network, wherein the audio query projection network includes a second self-attention layer, and wherein the audio query embedding is in the joint embedding space; and
providing an additional response to the audio query, wherein the additional response comprises the query modality.

6. The method of claim 1, further comprising:
generating a sequence of token embeddings based on the query using the query encoder network, wherein the query projection network takes the sequence of token embeddings as an input.

7. The method of claim 1, further comprising:
identifying timestamp information for the audio sample; and
identifying an additional audio sample based on the timestamp information.

8. The method of claim 1, wherein:
the response comprises a video sample comprising the audio sample.

9. The method of claim 8, further comprising:
identifying timestamp information for the audio sample; and
identifying the video sample based on the timestamp information.

10. A method for cross-modal retrieval, comprising:
identifying a training dataset including an audio sample in a sound modality and a corresponding sample in a corresponding sample modality other than the sound modality;
encoding the corresponding sample to obtain a corresponding sample embedding using a query encoder network for the corresponding sample modality and a query projection network, wherein the query projection network includes a first self-attention layer, and wherein the corresponding sample embedding is in a joint embedding space for the corresponding sample modality and the sound modality;
encoding the audio sample to obtain an audio embedding using an audio encoder network for the sound modality and an audio projection network, wherein the audio projection network includes a second self-attention layer, and wherein the audio embedding is in the joint embedding space; and
training the query projection network based on the audio embedding and the corresponding sample embedding.

11. The method of claim 10, further comprising:
training the audio projection network based on the audio embedding and the corresponding sample embedding.

12. The method of claim 10, further comprising:
computing a contrastive loss based on the audio embedding and the corresponding sample embedding; and
updating parameters of the query projection network based on the contrastive loss.

13. The method of claim 10, further comprising:
identifying metadata corresponding to the audio sample; and
combining the metadata with a template to obtain the corresponding sample.

14. The method of claim 10, further comprising:
identifying a pair of additional audio samples in the sound modality and a pair of additional corresponding samples in the corresponding sample modality;
combining the pair of additional audio samples to obtain the audio sample; and
combining the pair of additional corresponding samples to obtain the corresponding sample.

15. The method of claim 14, wherein:
the corresponding sample includes a prepositional phrase.

16. An apparatus for cross-modal retrieval, comprising:
at least one processor;
a memory storing instructions executable by the at least one processor;
a query encoder network configured to generate a sequence of token embeddings based on a query in a query modality other than a sound modality, wherein the query describes a sound; and
a query projection network configured to encode the sequence of token embeddings to obtain a query embedding in a joint embedding space for the query modality and the sound modality, wherein the query projection network includes a self-attention layer.

17. The apparatus of claim 16, further comprising:
a response component configured to provide a response including an audio sample based on the query embedding, wherein the audio sample includes the sound.

18. The apparatus of claim 16, further comprising:
an audio encoder network configured to generate a sequence of audio token embeddings based on an audio sample; and
an audio projection network configured to encode the sequence of audio token embeddings to obtain an audio embedding in the joint embedding space, wherein the audio projection network includes a second self-attention layer.

19. The apparatus of claim 16, further comprising:
a training component configured to identify a training dataset including an audio sample in the sound modality and a corresponding sample in in a corresponding sample modality other than the sound modality and to train the query projection network based on an audio embedding of the audio sample and a corresponding sample embedding of the corresponding sample.

20. The apparatus of claim 16, further comprising:
an audio encoder network configured to generate a sequence of audio query token embeddings based on an audio query;
an audio projection network configured to encode the sequence of audio query token embeddings to obtain an audio query embedding in the joint embedding space, wherein the audio projection network includes a second self-attention layer, and wherein the audio query embedding is in the joint embedding space; and
a response component configured to provide a response to the audio query, wherein the response comprises the query modality.
